(19) United States
(12) Patent Application Publication
(10) Pub. No.: US 2019/0086897 A1
(43) Pub. Date: Mar. 21, 2019

(54) SOFTWARE MODULE, PRECISION MACHINE, METHOD AND COMPONENT

(71) Applicant: Innolite GmbH, Aachen (DE)

(72) Inventors: Christian WENZEL, Aachen (DE); Simon FREUTEL, Duesseldorf (DE); Ralf WINKELMANN, Heinsberg (DE); Rainer KLAR, Eschweiler (DE)

(73) Assignee: Innolite GmbH, Aachen (DE)

(21) Appl. No.: 15/903,207

(22) Filed: Feb. 23, 2018

(30) Foreign Application Priority Data
Sep. 19, 2017 (DE) 10 2017 008 748.2

(51) Int. Cl. G05B 19/39; G05B 19/414; G05B 19/4099

(52) U.S. Cl. CPC G05B 19/39; G05B 19/4099; G05B 19/4145

(57) ABSTRACT

A software module calculates a 3D tool path with integrated reference variable generation for interpolating moving single axes of a precision machine. A precision machine has a control or drive servo-side interface, in order to read in advance for machining calculated files with equitemporal reference variables for interpolating single axes of the precision machine and to stream to the position and/or velocity controller of the respective individual axes. A method calculates a 3D tool path and a component is produced with this precision machine or with such a method.

### CROSS REFERENCE TO RELATED APPLICATIONS

Applicant claims priority under 35 U.S.C. § 119 of German Application No. 10 2017 008 748.2 filed Sep. 19, 2017, the disclosure of which is incorporated by reference.

### BACKGROUND OF THE INVENTION

### 1. Field of the Invention

The present invention relates to a software module for calculating a 3D tool path with integrated reference variable generation for interpolating moving single axes of a precision machine, a precision machine and a method for calculating a 3D tool path and a component produced with this precision machine or with such a method.

### 2. Description of the Related Art

In particular, the invention relates to methods for generating and processing reference variables of interpolating single axes for a production machine for path guidance of a tool in order to achieve accuracy and productivity increases over the prior art.

Production machines are continuously improved in order to achieve ever higher accuracies on the components to be manufactured. In addition to increasing accuracy, improving productivity is also of interest, which can be achieved through automation and faster machining speeds.

Influences on the accuracy of a production machine are manifold. Roughly speaking, the mechanics and control technology of the production machine can be named as the main influencing factors. The accuracy of a component which is manufactured on the machine is furthermore influenced by the process. These include, among others, the tool used, the set process parameters and environmental influences.

Accuracy considerations (characterization, optimization) in the mechanics include the rigidity at the tool center point, the precision of the individual axes of the production machine and in particular a machine tool (linear, rotary), for example, with aspects of degree, concentricity, angular errors (pitching, rolling, yawing), the precision of the position of the individual axes relative to each other (e.g., squareness, parallelism) and the thermal behavior of the mechanics (thermal symmetry, displacements of the tool center point, etc.). The invention relates in particular to increases in accuracy which go beyond mechanical increases in accuracy.

In order to guide a tool as accurately as possible along a path on a production machine, in addition to the mechanical accuracy of the machine, the control, including the target data preparation and processing, is of decisive influence. Influences can lead to accuracy reduction at all points in the chain from CAD (design process, definition of part geometry) via the CAD/CAM step (tool path generation for the tool for generating the part geometry) up to the CNC (break down of the tool path into single-axis motion instructions) and the position and velocity control loop (control of individual axes). The individual steps are explained in the following.

CAD (Computer Aided Design) programs are used to design components with surfaces to be manufactured. CAD programs use different mathematical approaches to describe surfaces (1), depending on the complexity of the surface (symmetric, free-formed, continuous, structured) and the accuracy to be realized. FIG. 1 schematically shows a surface 1 which can be described by point clouds 2 or can be approximated as closed surfaces by geometric elements. For example, triangular elements 3 in locally different sizes (resolution) are used to describe closed surfaces. Deviations to the ideal surface geometry arise in the CAD due to the approximations by surface elements, as it is provided for the component. These deviations are usually inherent in the finished component through a manufacturing process. The deviations can be shifted into the sub-micrometer range by local resolutions (e.g., leg length of the triangular geometries used for surface approximation). The data volumes and the associated necessary calculation times increase with such precision requirements. Typical formats in which such surfaces are exported from CAD programs and stored are IGES, STEP and native formats (e.g., Rhino *.3dm). Constructions with CAD programs occur exclusively in advance of machining cycles on a machine tool (offline) and are thus not immediately time-critical for the production and the generation of reference variables. In the case of increased accuracy requirements, the quality can be positively influenced by increased resolution with simultaneously longer computing time. A purely geometric description of a three-dimensional surface exists as a result of a CAD program.

CAD/CAM (CAM: Computer Aided Manufacturing) programs are used to calculate machining paths for defined tools for the production of the 3D component surface (from CAD). Thus, for example, a given milling tool 4 is repeatedly guided over a material blank 6 with a respective infeed 7 between the individual grid steps via a meandering grid 5 in order to generate a surface 8 on the component. The design of this tool path has a significant influence on the accuracy of the component. Obvious parameters are the depth of the infeed 9, the distance between the path sections 10 and the programmed tool velocity 11 along the path 12. All of these parameters have a major influence on the process control during the chip removal on the machine tool.

The distance of the 13 between interpolation points 14 and 15 (only numbered by example) for describing the path 12 and the interpolation between the interpolation points 13, 14—e.g., linear interpolation (see FIG. 4) or polynomial interpolation (see FIG. 5) are parameters during CAD/CAM processes that lead to further deviations 16 of the path 17, 18 in the tool guide by the machine tool with respect to the ideal geometry/ideal path 19. A reduction of these approximation errors is made in practice by narrow point distances (up to a few micrometers) and mathematically more complex interpolation routines between the points. Since CAD/CAM programs also run offline, i.e., before processing and with almost no time limit, the errors can be reduced to the single-digit nanometer range if the computing power and computing time are sufficiently available. The calculations that are made are generally of a purely geometric nature, the path is spatially described in three dimensions in a defined coordinate system.

As a result of a CAD/CAM calculation step, a G-code program is generated, which describes the tool paths for a component to be manufactured as a function of the process control and the machine tool used (post-processor). Approaches are known from the prior art, which also consider machine dynamic aspects in the path generation (e.g., NC Profiler, Aixpath). However, these considerations are disassociated from the actual CNC kernel, which calculates the interpolation and velocity control as part of the NC.

The CNC (Computer Numerical Control) controller gets a G-code program as a specification. This is a description of a spatial 3D path based on any number of interpolation points (block transition points) as well as the desired speeds between them. On the basis of this, the CNC calculates the movement profiles (reference variables) of the available interpolating individual axes 20, 21 and 22, taking into account the maximum permissible axis dynamics (acceleration, jerk, etc.) (see FIG. 6, using the example of x, y and z axes). The term “interpolation” is usually used for this in the literature (Manfred Weck, Werkzeugmaschinen Automatisierung von Maschinen and Anlagen (Machine Tools Automation of Machinery and Equipment), 5th Edition, p. 325).

As a result of the targeted interpolating movement of the individual axes, the tool is to be exactly guided on the spatial 3D path (18) in the example of the polynomial interpolation shown in FIG. 5 (i.e., with deviations up to an error to be defined) along the interpolation points 13, 14. Each interpolation point 13, 14 of the 3D path is composed of individual axis points (AP), 23, 24).

In addition to the purely geometric view of the surface in the CAD or CAD/CAM process step, spatially and temporally synchronized movements of the individual axes are determined in the CNC computing cycle. Thus, for individual axes, the necessary position (s) profiles 30 (position[m]), velocity (v) profiles 31 (velocity [m/s]), acceleration (a) profiles 32 (acceleration [m/s2]) and jerk profiles (j) 33 (in [m/s3], jerk=derivative of the acceleration) over time 35 taking into account the real performance of the machine tool (e.g., maximum accelerations, jerks) is calculated (see FIG. 7) in order to best follow the 3D path (Formula 1).

$${SP}_{1} ( \begin{matrix}x \\ y \\ z\end{matrix} ) {}_{G \text{-} Code » CNC} \begin{matrix}\begin{matrix}{AP}_{1 x} ( s , v , a , j ) \\ {AP}_{1 y} ( s , v , a , j )\end{matrix} \\ {AP}_{1 z} ( s , v , a , j )\end{matrix} \qquad Formula 1$$

In the simplest sense, the individual points along the path are approached one after another in such a way that at each point a complete stop of the tool is achieved (velocity=0). A corresponding velocity profile for an interpolating axis with the respective deviation 34 of the position (position error [m]) is shown in FIG. 7. However, such a specification is unfavorable for milling work, for example, since dynamic shaking is induced in the machine by the permanent acceleration and braking processes and the total machining time is extended. Mostly, a complete braking at respective interpolation points is not intended for an interpolating path guide.

In order to avoid the boundary condition v=0 at interpolation points, a so-called predictive velocity control (look-ahead) is implemented in the prior art. The look-ahead function analyzes several, usually between 100-1,000 blocks, in advance, in order to be able to react to changes in direction and velocity at an early stage. The look-ahead function takes into account the dynamic properties of the machine. Thus, a complete stop at the interpolation point can be safely bypassed. The default for the calculation is to traverse the path with the smallest possible deviation from the target velocity specified in the G-code with the available individual axes without exceeding a specified geometric deviation from the set path (error). For the sake of safety, the look-ahead ensures that the machine can stop completely at any time within the look-ahead block sequence. This can lead to a reduction of the velocity, in particular at high resolution and low interpolation point distance. The programmed set path for eight blocks is shown in FIG. 8. A velocity profile for the same geometric path with look-ahead function is shown in FIG. 9 and FIG. 10 shows a velocity profile for the same geometric path without a look-ahead function. It should be noted that for the execution of a G-code program (or a spline specification) for a 3D path, the parameters within the look-ahead function are constant (same number of blocks for the same dynamic parameter of the machine which is predicted, etc.).

It is characteristic of all state of the art CNC kernels that the path specified by a G-code (or spline) is not analyzed holistically, but executed point by point. In order to anticipate the future and to be able to plan velocities, accelerations and jerks as well as any necessary safety interventions (emergency stop), a fixed parameterized look-ahead is used, which works with a static number of blocks.

Unlike CNC or CAD/CAM steps, the CNC calculation cycles (i.e., interpolation, predictive velocity control) always run on the control computer of the individual machine in real time parallel to the machining. Thus, there are binding time limitations that limit the calculation time for a target value according to Formula 1. An increase in precision due to longer calculation times, as is possible in the CAD/CAM process step, does not work according to the current state of the art.

This results in an optimization task for the increase in accuracy during the CNC calculation cycles, which consists of the coordination of the following three variables:

1. Number of interpolation points to describe the path

2. Interpolation routines between interpolation points

3. Performance of the computer (usually iPC)

For 1: the higher the number of interpolation points along the path that can be chosen, the smaller the local deviations from the ideal tool path or the ideal component geometry turn out (FIG. 4, (15)). For an identical path velocity, however, more arithmetic operations according to formula 1 must be carried out with increased interpolation point density. It requires more computing power.

For 2: In addition to the number of interpolation points themselves, the complexity of the calculation steps from point to point influences the computing time. There are serious differences in the arithmetic operations between two points depending on whether there is linear or by polynomial or spline interpolation. Thus, in polynomials of higher order, velocities, accelerations and jerks can be calculated cleanly by local derivatives, but the computation time for such operations is significantly higher in comparison to the mathematical limitation of dynamic values in non-continuous linear interpolation. This means that one can choose a mathematically better interpolation algorithm between interpolation points, which leads to better path behavior, but this leads to a reduction of the convertible interpolation points or to a significant reduction of the processing speed for a given computing power.

For 3: the performance of the computer can positively influence the compromise between the number of calculated interpolation points, depending on the complexity of the mathematical approach used. Common iPCs in machine control systems (Heidenhain, Siemens, Bosch, Fanuc) are capable of calculating approx. 500-1,000 interpolation points per second with polynomial-based interpolation. With this approach, good surface roughness values, especially in the case of micro-structured geometries, are countered by a poorer shape retention. If the mathematically simpler linear block interpolation between the interpolation points is selected, depending on the number of interpolating axes, even up to 3,000 interpolation points per second can be calculated (Beckhoff). The increase in resolution thus achieved is usually countered by a worse surface roughness resulting from noisy acceleration and jerk profiles. This noise occurs as a result of the non-continuous transitions caused by the linear interpolation at the individual interpolation points. In addition, the state-of-the-art software architecture of CNC kernels does not permit the use of multiple kernels of an iPC for the computation. The performance of the computer is correspondingly related to the efficiency of a single kernel.

The target data derived from the CNC for axis points (Formula 1, right) are then forwarded to the position and velocity controller of the individual axes. This control can be localized on the control computer (central) (e.g., Delta Tau Control, PMAC) or run decentrally on the respective servo amplifier of the single axis.

Central approaches are often followed for high-precision and ultra-precision applications (e.g., Moore Nanotech, USA). The power amplifier for the motor current is then designed as a pure special low-noise linear amplifier (see HIFI amplifier). Particularly good surface roughness can be achieved by this approach, as is required in diamond turning. In the central approach, however, the position and velocity control loops on the control computer (iPc) run at maximum clock rates of 2,000 to 3,000 Hz. The geometric accuracy of this architecture is limited due to the limited number of interpolation points, especially in micro-structured surfaces.

Alternatively, the decentralized approach can use digital power amplifiers for the drives. In addition to the usual manufacturers with clock frequencies of 8-32 kHz, there are now also high-performance systems with position and current controller clock rates of up to 100 kHz. Such controllers are operated in the corresponding servo amplifiers on FPGA (Field Programmable Gate Array). With regard to the achievable control quality (contouring error of the single axis, difference between target and actual position value), such servo amplifiers allow extreme improvements compared to central approaches (factor 50 higher number of controlled points along the tool path).

An obviously limiting factor in the context of a high interpolation point density with mathematically advantageous (polynomial-based) computational approaches, according to the current state of the art, is the CNC, which calculates on iPCs the calculation of the interpolating single axis profiles on the basis of a G-code (3D path description).

### SUMMARY OF THE INVENTION

It is therefore the object of the present invention to increase the precision and the productivity of production machines by a novel type of reference variable generation with respect to the state of the art.

This object is achieved with a software module having the features according to one aspect of the invention, a precision machine having the features according to another aspect of the invention and a method having the features according to a further aspect of the invention. Advantageous further developments of the invention are discussed below. In particular, in certain embodiments, the streaming can be done by the control computer of the machine tool or by an external computer. Further embodiments will become apparent from the description and the figures.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 schematically shows a surface which can be described by point clouds or can be approximated as closed surfaces by geometric elements.

FIG. 2 shows a milling tool guided over a material blank with a respective infeed between the individual grid steps via a meandering grid in order to generate a surface on the component.

FIG. 3 shows the distance between interpolation points for describing the path.

FIG. 4 shows a linear interpolation.

FIG. 5 shows a polynomial interpolation.

FIG. 6 shows a movement profile using the example of x, y, and z axes.

FIG. 7 shows determination of spatially and temporally synchronized movements of the individual axes taking into account the real performance of the machine tool.

FIG. 8 shows the programmed set path for eight blocks.

FIG. 9 shows a velocity profile for the geometric path of FIG. 8 with a look-ahead function.

FIG. 10 shows a velocity profile for the geometric path of FIG. 8 without a look-ahead function.

FIG. 11 shows the reference variables for a simple movement of an axis between two points calculated via the polynomial-based offline approach according to the invention.

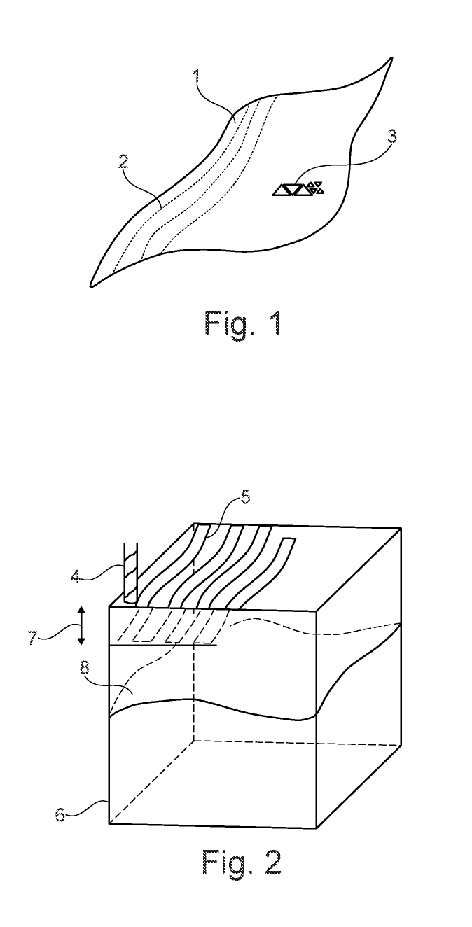

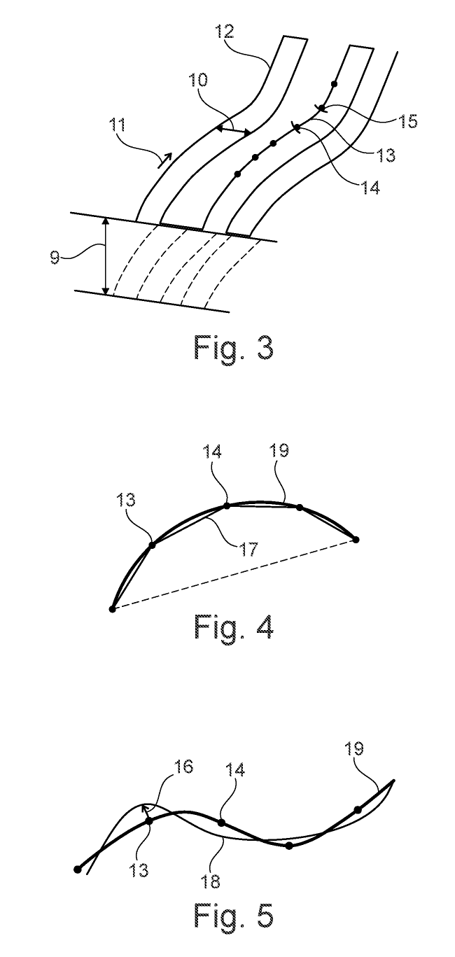

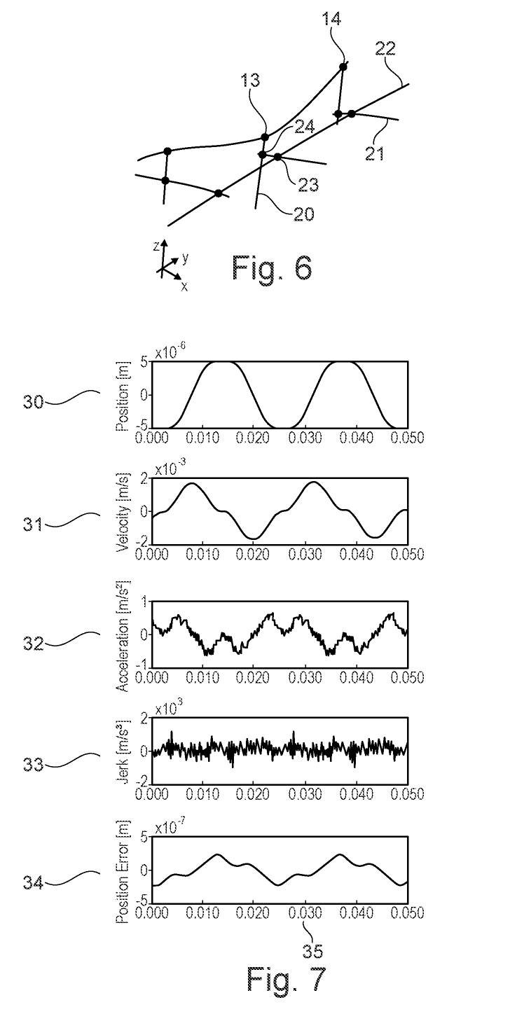

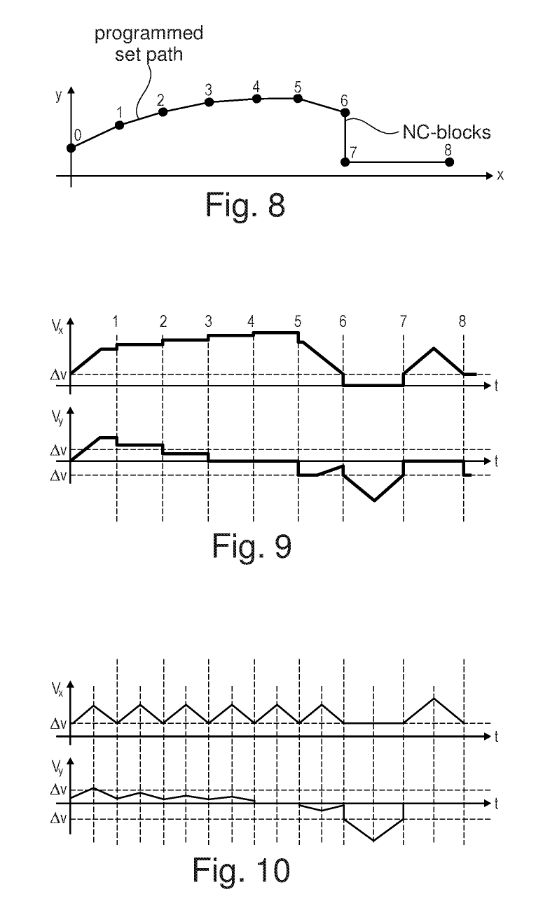

### DETAILED DESCRIPTION OF PREFERRED EMBODIMENTS

The procedure described is not an optimization step during the CAD/CAM routine, but rather the actual functionality of the CNC. The calculated data are preferably no longer pushed through another CNC kernel, but flow directly to the position controller of the single axis.

Using the look-ahead in a conventional CNC control, a velocity planning for the guidance of the tool is carried out in such a way a following of the path is realized as quickly as possible, taking into account the specified target speed, without violating the contour (geometry).

Acceleration and jerk are calculated as a result of the velocity planning. If there are overshoots of predefined limit values during acceleration or jerk, the velocity is reduced at the respective points until the permissible limit values are exceeded.

As a result, the limit values of velocity, acceleration or jerk are never exceeded across the entire path. However, it may be that the course of the acceleration and the jerk is very uneven or noisy. This leads to dynamic unwanted excitations in the machine, which lead to a deterioration of the surface quality.

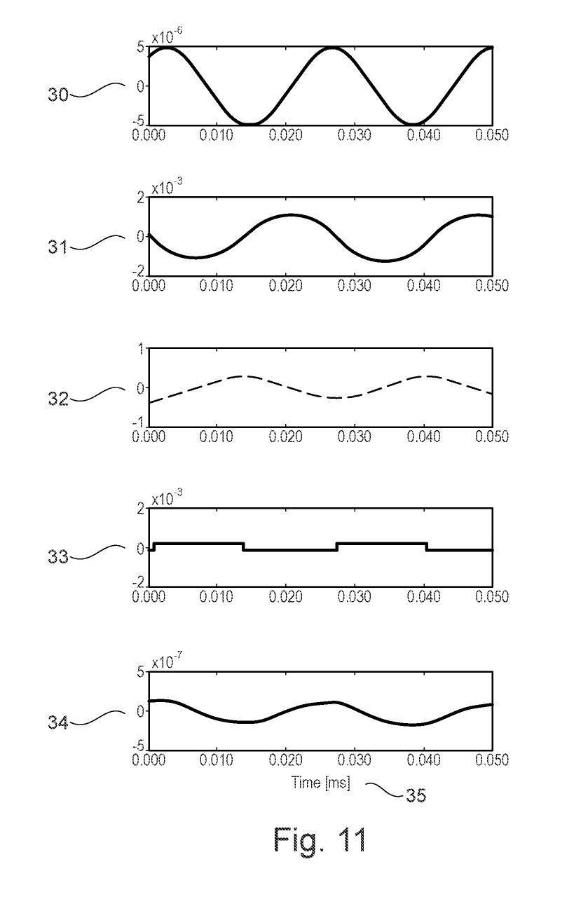

FIGS. 7 and 11 show the reference variables for a simple movement of an axis between two points. FIG. 7 was conventionally calculated via a CNC linear block and FIG. 11 via the polynomial-based offline approach according to the invention. In particular, the differences in acceleration and jerk are noticeable in this case.

This makes it possible, if necessary (there may be many reasons for a higher frequency excitation, e.g., surface structure, limit movement cases of the axes, chipping of special materials) for velocity, acceleration and jerk to optionally introduce new smoothing functions that not only locally control and reduce a limit value (and thereby lead to high-frequency excitation), but achieve a continuous smoothing and thus a calming of the tool guide over a sub-segment of the path. Such a smoothing function results in influencing or reducing the velocity in the respective area.

In practice, the method can be described in three steps:

1. Calculating all reference variables with temporal reference (velocity, acceleration, jerk) for the individual axes on the basis of a starting velocity, which is not a reference variable.

2. Adjusting these calculated reference variables locally along the entire 3D path such that predefined maximum values for velocity, acceleration, jerk are not exceeded.

3. Smoothing the adjusted reference variable profiles for velocity, acceleration, and jerk along parts according to a given requirement, such as short machining time (smooth, maximized velocity), or good surface roughness (smoothing the acceleration profile of the axes for smooth behavior). In this case, the smoothing of any desired reference variable profile (e.g., acceleration) always has an influence on all other profiles (e.g., jerk, velocity).

This makes it possible to increase the machining velocity significantly and to increase the quality of the machining by an increased number of interpolation points per second. This is needed for precision machines and especially for high-precision machine tools to be able to produce, for example, structures for head-up displays significantly faster.

A novel feature with respect to the prior art is the possibility of making a continuous adjustment of the spindle velocity up to a maximum value with the method without there being any influence on surface quality.

Although only a few embodiments of the present invention have been shown and described, it is to be understood that many changes and modifications may be made thereunto without departing from the spirit and scope of the invention.

What is claimed is:

1. A software module for calculating a 3D tool path with integrated reference variable generation for interpolating moving single axes of a precision machine, wherein as interface output of the software module for controlling the precision machine, position target values are output as a reference variable for each interpolating moving single axis of the precision machine with equitemporal distances in a continuous individual file or a plurality of individual files.

2. The software module according to claim 1, wherein as interface output, in addition to the position target values of the individual axes, velocity, acceleration or jerk values with equitemporal intervals are output as additional reference variables for the single-axis control.

3. The software module according to claim 1, wherein the calculation of the reference variables is carried out analytically in order to follow with a previously defined working contour, such as in particular a cutting contour of the tool, the 3D tool path underlying the calculations exactly or up to a defined residual error.

4. A precision machine with a control or drive servo-side interface, in order to read in advance for machining calculated files with equitemporal reference variables for interpolating single axes of the precision machine and to stream to the position and/or velocity controller of the respective individual axes.

5. A method for calculating a 3D tool path with integrated reference variable generation for interpolating moving single axes of a precision machine, wherein for the control of the precision machine, position target values are output as a reference variable for each interpolating moving single axis of the precision machine with equitemporal distances in a continuous individual file or a plurality of individual files.

6. The method according to claim 5, wherein the calculation of the reference variables for the interpolating individual axes is carried out such that the velocity of a main spindle in the axis group is continuously increased to a defined maximum value to ensure a constant longest possible cutting velocity in the turning process.

7. The method according to claim 5, wherein a starting velocity for all individual axes along a complete 3D path or a subsystem of the individual axes in a partial projection of the 3D path is specified and before driving the individual axes, the other reference variables of the individual axes are fully calculated with temporal reference such as speed, acceleration and/or jerk.

8. The method according to claim 7, wherein after the calculation of the reference variables based on the starting velocity, the reference variables velocity, acceleration and jerk are maximized taking into account predetermined dynamic limit values locally along the entire 3D path.

9. The method according to claim 8, wherein after local maximization of the reference variables velocity, acceleration and jerk, the respective reference variable profiles, in particular acceleration and jerk, are smoothed over individual sub-segments of the path in order to achieve an increase in precision on these sub-segments in particular with respect to dimensional stability or surface roughness.

10. The method according to claim 5, wherein before controlling the individual axes, a complete reference variable data set is calculated and optimized analytically precisely for the entire 3D space curve or subsections of the curve.

11. The method according to claim 10, wherein for the creation of the reference variable data set, iterative, numerical calculations or analytically precise calculations for the interpolation are performed in parallel on several kernels and then assembled in a synchronized manner in order to achieve an acceleration of the production compared to single-kernel calculations.

12. The method according to claim 5, wherein by an analytical calculation, a number of the position target values per single axis greater than 3,000 points/s, preferably greater than 5,000 points/s or even greater than 10,000 points/s, are output in polynomial-based calculation.

13. The method according to claim 5, wherein the motion profiles are stored in files as a buffer before the control of the individual axes, which are streamed with data rates greater than 3,000 points/s, advantageously greater than 5,000 points/s or even greater 10,000 points/s, directly to a servo to drive a single axis with decentralized integrated position control.

14. The method according to claim 5, wherein the motion profiles are stored in files as a buffer before the control of the individual axes, which are streamed with data rates greater than 3,000 points/s, advantageously greater than 5,000 points/s or even greater 10,000 points/s, directly to a position controller which runs centrally on a computer of precision machine.

15. The method according to claim 13, wherein during the streaming of the pre-calculated values, the path velocity of the tool is influenced by a limiting actuator (override).

16. The method according to claim 13, wherein the files are called from a conventional CNC program of the precision machine as a subroutine, started and terminated.

17. A component manufactured by a precision machine according to claim 4.

18. A component manufactured by a method according to claim 5.
